(19) United States
(12) Patent Application Publication
(10) Pub. No.: US 2018/0347384 A1
(43) Pub. Date: Dec. 6, 2018

(54) SEALING SYSTEM WITH WELDED-ON SEALING PLATE, TURBOMACHINE, AND MANUFACTURING METHOD

(71) Applicant: MTU Aero Engines AG, Muenchen (DE)

(72) Inventors: Bernd KISLINGER, Reisgang (DE); Rudolf STANKA, Rattenkirchen (DE); Manfred SCHILL, Muenchen (DE); Manfred FELDMANN, Eichenau (DE)

(21) Appl. No.: 15/995,304

(22) Filed: Jun. 1, 2018

(30) Foreign Application Priority Data
Jun. 2, 2017 (DE) 102017209420.6

(51) Int. Cl. F01D 11/00

(52) U.S. Cl. CPC F01D 11/001; F05D 2260/30; F05D 2240/55; F05D 2230/232

(57) ABSTRACT

A sealing system (100) for a turbomachine is provided which includes a support (10) designed as a ring part, and a ring-like sealing plate (20, 30) that protrudes from the support in the axial direction (X). The support includes a fastening section (11) for fastening the sealing system to a stator part (200), and a retaining area (12), situated radially within the fastening section, for retaining a radial gap seal (40). The sealing plate (20, 30) is welded to the support (10) radially outside the retaining area (12). Also provided are a turbomachine that includes a sealing system (100), a support (10) for a sealing system, and a method for manufacturing a sealing system.

This claims the benefit of German Patent Application DE 102017209420.6, filed Jun. 2, 2017 and hereby incorporated by reference herein.

The present invention relates to a sealing system, a support for a sealing system, a turbomachine, and a method for manufacturing a sealing system.

### BACKGROUND

Sealing systems are routinely used in turbomachines such as aircraft engines for sealing spaces between rotating engine components and stationary engine components. They allow damage-free run-in of vane tips, sealing webs, and the like, and result in a reduction in leakage flows.

In particular, sealing systems are used which are fastened to a stator element (in particular a guide vane) and which include a radial gap seal such as a honeycomb element in particular, that cooperates with a sealing element (a sealing fin, for example) on the rotor side; in the present document, unless stated otherwise the terms “radial,” “axial,” and “circumferential direction” and terms derived therefrom are understood to mean in relation to a (provided) rotational axis of the rotor.

The publication DE 10 2012 201 050 A1 provides a sealing system that includes two rings, each with supports that include a U-shaped sheet metal profile, for connection to a stator section. The rings each include in particular an inner flange for fastening a plurality of base bodies that are used for accommodating a honeycomb element. The outer legs of the rings are used to stabilize the support.

Manufacturing the sheet metal rings requires a plurality of segments that must be situated in succession in the circumferential direction. Therefore, manufacturing this type of sealing system is complicated.

A fish mouth sealing system is known from EP 2 722 486 B1, with two half-shell elements which in the area of a honeycomb seal are integrally joined flush to one another. The half-shell elements are each designed as one part with a sealing element situated farther radially outward, which functions as a deflector for the fish mouth seal.

However, achieving a stable, integrally joined connection of the half-shell elements to one another in the vibration-intensive area of the honeycomb seal, likewise as for the manufacture of the half-shell elements designed as one part with the outwardly situated sealing elements, is complicated.

### SUMMARY OF THE INVENTION

It is an object of the present invention to provide an alternative technique which in particular allows simplified manufacture of a sealing system, as well as a weight savings.

The present invention provides a sealing system, a turbomachine, a support for a sealing system, and a method for manufacturing a sealing system.

A sealing system according to the present invention for a turbomachine includes a support designed as a ring part, i.e., as an element forming a ring sector, for example a half-ring having a center axis angle of 180° or a full ring having a center axis angle of 360°, which thus completely surrounds a central middle axis (which preferably coincides with a provided rotor axis of the turbomachine). The support has a fastening section to which the sealing system may be fastened at a stator part (for example, a section of a guide vane, in particular a radially inner guide vane tip or a radially inner guide vane platform); the support, for example in the fastening section, may form a groove that extends in the circumferential direction and protrudes radially into the support from the outside to the inside, or may include a plurality of receptacles that extend radially in the support, into which a section of the stator part may be inserted in each case. According to one advantageous specific embodiment, the section of the stator part and the support include mutually corresponding boreholes in the axial direction, in such a way that the stator part may be fixed with the aid of a bolt that is or may be inserted through the boreholes in the support and the boreholes in the stator part.

The support of a sealing system according to the present invention also includes a retaining area that is configured for retaining a radial gap seal (such as a honeycomb seal element) for sealing a radial gap between the rotor and the stator of the turbomachine (with the aid of a soldered joint, for example); according to one advantageous specific embodiment, the sealing system includes a radial gap seal that is affixed, for example soldered, to the retaining area.

A sealing system according to the present invention also includes a ring-shaped sealing plate that protrudes from the support in the axial direction and is welded to the support radially outside the retaining area (for the radial gap seal). In particular, the sealing system thus includes a corresponding weld seam between an edge of the sealing plate and the support.

The sealing plate, which is preferably spaced apart from the retaining area in the radial direction, is thus configured to deflect and decelerate flows in the annular space of the turbomachine (for example, together with a radially inner guide vane platform and/or at least one projection on a neighboring row of moving vanes), and thus, to act overall as a seal and reduce leaks.

The sealing plate is preferably designed as a strip having a surface which extends in the axial direction (which represents a width of the strip) and which completely or partially surrounds the center axis of the ring part (i.e., the provided rotor axis). In particular, the sealing plate may preferably protrude from the support at least 10 mm or at least 12 mm, and/or at most 15 mm or at most 13 mm, in the axial direction, so that an edge of the sealing plate opposite from the welded-on edge, and thus, from the weld seam, has a corresponding minimum or maximum axial distance from the support. According to one advantageous specific embodiment, the distance of an edge of the sealing plate, opposite from the weld seam, from the support is at least 90% of an axial extension of the retaining area in the same direction. In particular, the sealing plate may protrude beyond a (farther radial inwardly situated) edge of the retaining area in the axial direction.

A radial distance of the sealing plate from the retaining area is preferably at least 75%, preferably at least 85% and/or at most 125% or at most 115% of the distance of an edge of the sealing plate, opposite from the weld seam, from the weld seam (i.e., the width of the sealing plate measured in the axial direction).

The support preferably has a monolithic design. It may be manufactured with the aid of a primary forming method, for example. One specific embodiment is preferred in which the support is designed as a turned part, i.e., is manufactured with the aid of (cutting) turning. This allows a design of the support which on the one hand is particularly simple, and on the other hand is solid.

Accordingly, in one of the specific embodiments provided in the present document, a support according to the present invention is designed as a turned part and is configured to be used as a support of a sealing system. The support is preferably designed as a monolith and/or as a ring that completely surrounds a center axis along a circular path.

According to one of the specific embodiments provided in the present document, a turbomachine according to the present invention includes a sealing system according to the present invention and at least one stator part that is affixed to the fastening section of the support of the sealing system.

According to one of the specific embodiments provided in the present document, a method according to the present invention is used for manufacturing a sealing system according to the present invention. The method includes manufacturing the (preferably monolithic) support (with a fastening section for a stator part, and a retaining area for a radial gap seal), and welding at least one sealing plate at its edge to the support, in particular farther radially outwardly than the retaining area and in such a way that the sealing plate protrudes from the support in the axial direction; according to one preferred specific embodiment, the support is manufactured with the aid of (cutting) turning. The sealing plate may initially be manufactured as a flat sheet metal strip, and then bent in the circumferential direction before it is welded to the support.

Due to the sealing plate that is (subsequently) affixed or is to be affixed to the support by welding, a sealing system according to the present invention, a turbomachine according to the present invention, a support according to the present invention, and a method according to the present invention on the one hand allow simple manufacture of the support, which thus also has a stable design and which as an individual part may, for example, be easily transported and stored. On the other hand, the welding allows a sealing plate with a particularly thin design, which means a weight savings in the turbomachine which in particular reduces fuel consumption.

One specific embodiment of the present invention is particularly preferred in which two sealing plates are welded to opposite sides of the support in the axial direction. One of the sealing plates then correspondingly protrudes from the support, opposite from a provided main flow direction, and the other sealing plate protrudes in the provided main flow direction. Such a sealing system allows particularly effective deflections of radial flows, and provides the stated advantages during manufacture and storage.

The two sealing plates may be provided or welded essentially symmetrically or asymmetrically with respect to the support. In particular, the sealing plates may both be welded at essentially the same distance or at different distances from the retaining area or the center axis of the support designed as a ring part (the center axis preferably coinciding with the rotor axis that is provided or present).

The sealing plate, or just one or both of the sealing plates, may (each) include a section in which it/they is/are bent radially inwardly. In particular, the sealing plate or one or both of the sealing plates may have an edge opposite from the welded-on edge (i.e., an edge that protrudes from the support with the greatest axial distance) that is bent radially inwardly, i.e., facing a center axis of the support designed as a ring part. Such a section or edge that has been or may be bent prior to the welding allows a particularly advantageous influence on radial flows.

One specific embodiment is advantageous in which the sealing plate or one or both of the sealing plates has/have an average thickness (measured in the radial direction) that is at most 1.5 mm or at most 1 mm and/or at least 0.5 mm or at least 0.6 mm. In this way, a particularly great weight savings may be effectuated, and required stability may (nevertheless) be ensured.

The fastening section of the support may include an annular area (with a surface that extends in the radial direction) that is configured for resting on one side against a first surface area of the stator part, while a second surface area of the stator part axially opposite from the first surface area is exposed. In this case, a meridian section of the sealing system in the area of the annular area thus has an asymmetrical design of the fastening section. The one-sidedness of the support (which provides axial fixing) simplifies insertion of the stator part into the fastening section, and represents a weight savings. In particular, the annular area is preferably part of the monolithically designed support. The annular area preferably includes a surface section that is situated farther radially outwardly than a welded-on sealing plate (preferably on the same side of the support).

The sealing plate may be placed on an essentially flat surface area of the support and welded on, so that the support extends beyond a corresponding weld seam in the radial direction. Alternatively, the sealing plate may be placed on a radially outwardly situated edge of the support and welded there, or it may be placed (preferably with a butt joint, i.e., flush) on an edge that protrudes from a support surface in the axial direction and welded there. Such an edge may protrude from the support surface in the axial direction, for example, at least 2.5 mm or at least 3 mm and/or at most 4.8 mm, preferably at most 4.1 mm. In specific embodiments with two sealing plates welded on at opposite sides of the support, a first of the sealing plates may be placed or mounted and welded on in a first of the stated ways, and a second sealing plate may be placed or mounted and welded on in a second of the stated ways that is different from the first, or both sealing plates may be simultaneously placed or mounted on the support and welded on.

### BRIEF DESCRIPTION OF THE DRAWINGS

Preferred exemplary embodiments of the present invention are explained in greater detail below with reference to the drawings. It is understood that individual elements and components may also be combined in a different way than described. Reference numerals for mutually corresponding elements are used throughout the figures, and are not described anew for each figure.

FIG. 1 schematically shows a sectional area of a meridian section of an example of a sealing system according to the present invention; and

FIG. 2 schematically shows a section of a turbomachine according to the present invention, with the sealing system illustrated in FIG. 1 in a meridian section.

### DETAILED DESCRIPTION

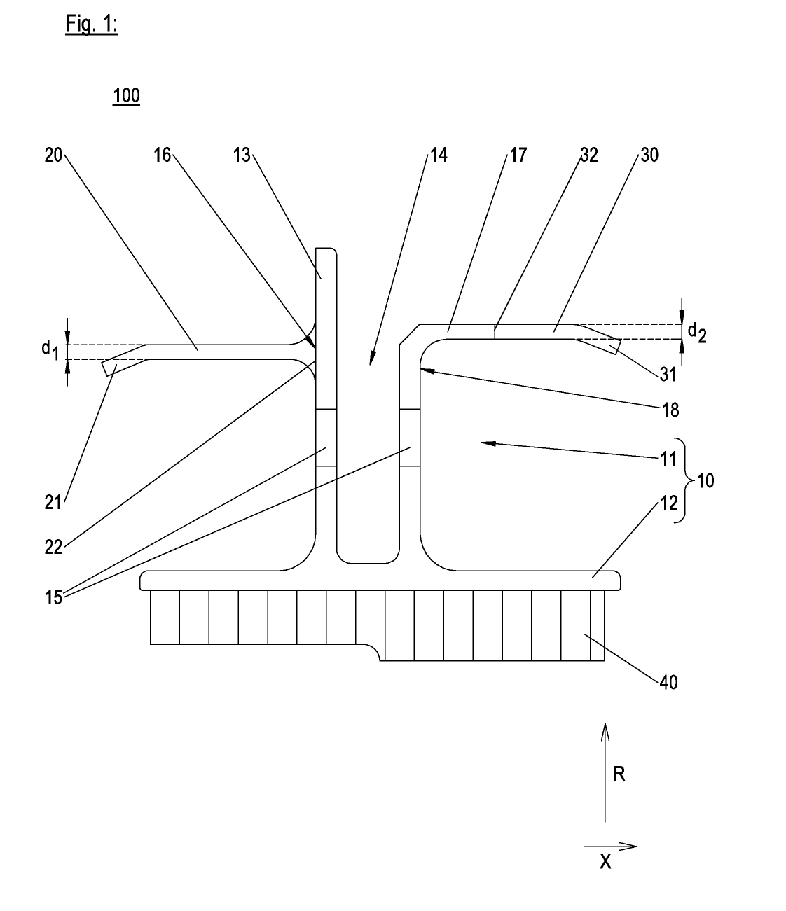

FIG. 1 illustrates a sectional area of a meridian section of one specific embodiment of a sealing system 100 according to the present invention along a provided rotor axis that extends in axial direction X. It is understood that in the case that the sealing system forms a full ring, the entire meridian section includes an oppositely situated (relative to the rotor axis) second sectional area which preferably has an analogous design.

Sealing system 100 includes a (preferably monolithic) support 10 that includes a fastening section 11 and a retaining area 12. The support 10 is designed as a ring part (not discernible in the figure), and as such completely or partially surrounds a central axis that coincides with the provided rotor axis. The support is preferably designed as a turned part, i.e., is manufactured with the aid of cutting turning.

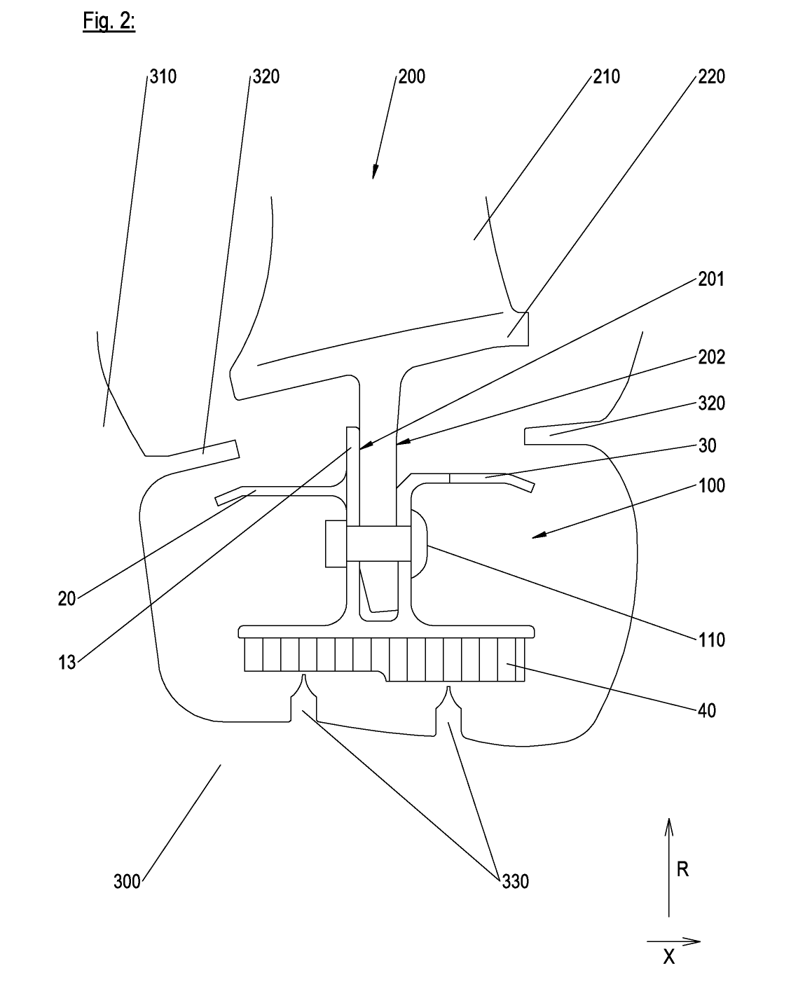

Fastening section 11 is configured for being fastened to a stator part such as a section of a guide vane, for example. The fastening section includes an annular groove 14 which protrudes radially into the support from the outside into the inside and into which the stator part may be inserted. A borehole 15 passes through the two side walls of the annular groove. A stator part that is inserted or is to be inserted preferably likewise includes a borehole at the corresponding location, so that, as shown in FIG. 2, a bolt 110 may be guided through the side walls of the annular groove and stator part 200 in order to fix the latter in annular groove 14. Bolt 110 may be riveted or screwed, for example, in this position.

The two side walls of annular groove 14 have different extensions in radial direction R: Thus, at one of the side walls an annular area 13 is formed which, as is once again apparent in FIG. 2, is configured for resting on one side against a first surface area 201 of an inserted stator part 200, while a second surface area 202 of the stator part axially opposite from surface area 201 is exposed.

Retaining area 12 is situated radially within fastening section 11 (i.e., farther inwardly than the fastening section, relative to radial direction R). The retaining area retains a radial gap seal 40 that is provided for sealing a radial gap between the stator and the rotor. In the illustrated example, radial gap seal 40 is designed as a honeycomb seal which may be soldered, for example, to retaining area 12 of support 10 (preferably under vacuum).

Sealing system 100 also includes two sealing plates 20, 30 that are welded to support 10 radially outside retaining area 12 and spaced apart from same, so that the sealing system includes corresponding weld seams 22, 32. The sealing plates protrude from support 10 on mutually opposite sides in axial direction X. At their edges 21, 31 opposite from respective weld seam 22, 32, which are axially farthest away from the support, the sealing plates are each bent radially inwardly. In this way, radial flows may be advantageously deflected inwardly, and leaks may thus be reduced overall.

Sealing plates 20, 30 each have an average thickness d1 and d2, respectively, that is preferably at most 1.5 mm or at most 1 mm and/or at least 0.5 mm or at least 0.6 mm. Thicknesses d₁ and d₂ of the two sealing plates 20, 30 may be the same or different.

In the illustrated exemplary embodiment, sealing plate 20 is welded on farther radially inwardly than second sealing plate 30. In particular, sealing plate 20 is placed on a flat surface area 16 of support 10 and welded on there, so that support 10 extends radial outwardly beyond weld seam 22. In the exemplary embodiment shown, the support forms annular area 13 there.

In contrast, sealing plate 30 is placed on an edge 17 that protrudes from support surface 10 in axial direction X and is welded on there, and thus protrudes from support 10 in the opposite direction from first sealing plate 20. An extension of edge 17 from support surface 18 in the axial direction is preferably at least 2.5 mm or at least 3 mm and/or at most 4.8 mm, preferably at most 4.1 mm.

FIG. 2 shows sealing system 100 in the interior of a turbomachine: the sealing system, as described above, is fastened to a stator part 200 in the form of a guide vane that includes a guide vane airfoil 210 and a platform 220. A rotor 300 includes sealing fins 330 that are configured for running into radial gap seal 40 of the sealing system, and together with same sealing off the radial gap between rotor 300 and stator part 200. It is understood that rotor 300 may be made up of multiple individual parts.

Radial flows that occur are deflected by sealing plates 20, 30 of sealing system 100 together with projections 320 at moving vanes 310 adjacent to guide vane 200, and with platform 220 of guide vane 200, and are thus decelerated, thereby reducing leaks.

A sealing system 100 for a turbomachine is provided which includes a support 10 designed as a ring part, and a ring-like sealing plate 20, 30 that protrudes from the support in axial direction X. The support includes a fastening section 11 for fastening the sealing system to a stator part 200, and a retaining area 12, situated radially within the fastening section, for retaining a radial gap seal 40. Sealing plate 20, 30 is welded to support 10 radially outside retaining area 12.

Also provided are a turbomachine that includes a sealing system 100, a support 10 for a sealing system, and a method for manufacturing a sealing system.

### LIST OF REFERENCE NUMERALS

10 support
11 fastening section
12 retaining area
13 annular area
14 annular groove
15 borehole
16 surface area of the support
17 edge protruding from support surface 18
18 support surface
20, 30 sealing plate
21, 31 edge of the sealing plate
22, 32 weld seam
40 radial gap seal
100 sealing system
110 bolt
200 stator part (in the form of a guide vane)
201, 202 surface area of the stator part
210 guide vane airfoil
220 platform
300 rotor
310 moving vane
320 projection of the row of moving vanes
330 sealing fin
d₁, d₂ average thickness of sealing plate 20, 30
R radial direction
X axial direction

What is claimed is:

1. A sealing system for a turbomachine, the sealing system comprising:
a support designed as a ring part, and having a fastening section for fastening the sealing system to a stator part, and a retaining area, situated radially within the fastening section, for retaining a radial gap seal; and
a ring-shaped sealing plate protruding from the support in an axial direction and welded to the support radially outside the retaining area.

2. The sealing system as recited in claim 1 wherein the support is a turned part.

3. The sealing system as recited in claim 1 wherein an edge of the sealing plate protruding farthest from the support in the axial direction is bent radially inwardly.

4. The sealing system as recited in claim 1 wherein an average thickness of the sealing plate is at most 1.5 mm.

5. The sealing system as recited in claim 1 wherein an average thickness of the sealing plate is at most 1.0 mm.

6. The sealing system as recited in claim 1 wherein an average thickness of the sealing plate is at least 0.5 mm.

7. The sealing system as recited in claim 1 wherein an average thickness of the sealing plate is at least 0.6 mm.

8. The sealing system as recited in claim 1 wherein the fastening section includes an annular area configured for resting on one side against a first surface area of the stator part, while a second surface area of the stator part axially opposite from the first surface area is exposed.

9. The sealing system as recited in claim 8 wherein the annular area includes a surface section that extends radially outside the sealing plate in the radial direction.

9. The sealing system as recited in claim 1 wherein the sealing plate is a first sealing plate, and further comprising at least one second ring-shaped sealing plate welded to the support and protruding from the support in the axial direction, opposite from the first sealing plate.

10. The sealing system as recited in claim 9 wherein the first and the second sealing plates are welded on at a same distance from a center axis of the support.

11. The sealing system as recited in claim 9 wherein the first and the second sealing plates are welded on at different distances from a center axis of the support.

12. The sealing system as recited in claim 1 wherein an edge of the sealing plate or of a further sealing plate:
is placed on a flat surface area of the support,
is mounted on a radially outwardly situated support edge of the support, or
is flush mounted on a protruding edge protruding from a support surface in the axial direction; and welded on.

13. A turbomachine comprising the sealing system as recited in claim 1, and at least one stator part fastened to the fastening section of the support of the sealing system.

14. A support for the sealing system, the support comprising:
a ring part, and having a fastening section for fastening the sealing system to a stator part, and a retaining area, situated radially within the fastening section, for retaining a radial gap seal, the support designed as a turned part and having a weld area for a ring-shaped sealing plate protruding from the support in an axial direction, the weld area being radially outside the retaining area.

15. A method for manufacturing a sealing system as recited in claim 1, the method comprising:
manufacturing the support; and
welding the sealing plate to the support radially outside the retaining area so that the sealing plate protrudes from the support in the axial direction.

16. The method as recited in claim 15 wherein the manufacturing step takes place with the aid of turning.
